(19) United States
(12) Patent Application Publication
(10) Pub. No.: US 2026/0303736 A1
(43) Pub. Date: Oct. 1, 2026

(54) DOCUMENT CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: TAKAYUKI FUKUSHIMA, Ibaraki (JP)

(21) Appl. No.: 19/577,142

(22) Filed: Mar. 24, 2026

(30) Foreign Application Priority Data
Apr. 1, 2025 (JP) 2025-060808

(51) Int. Cl. H04N 1/00

(52) U.S. Cl. CPC H04N 1/00615; H04N 1/00588; H04N 1/00591; H04N 1/00602; H04N 1/00795

(57) ABSTRACT

A document conveyance apparatus is provided that includes a reading section, a reading unit for reading an image of a conveyed document, and scoop-up guides disposed at intervals in a width direction perpendicular to a conveyance direction, configured to pick up and guide a leading edge of the document into the document conveyance apparatus, a conveyance member for conveying the document, a conveyance guide member movable in a document thickness direction and to guide the document at a reading position of the reading unit, rotational members provided in the conveyance guide member, disposed downstream of the reading position in the conveyance direction, and swingable guide members swingably arranged alternately with the scoop-up guides in a state in which the document conveyance apparatus is closed with respect to the reading section. The swingable guide members are disposed at positions that face at least one of the rotational members.

### BACKGROUND

### Field of the Technology

The present disclosure relates to a document conveyance apparatus that conveys documents, an image reading apparatus, and an image forming apparatus, both of which include the document conveyance apparatus.

### Description of the Related Art

Conventionally, there have been known conventional image reading apparatuses each provided in an image forming apparatus, such as a copying machine, including an ADF that conveys documents placed on a document tray one by one.

If the document reading speed of the ADF changes during document reading, the read image quality deteriorates. Thus, the conveyance of documents is to be stabilized particularly at the reading position. In Japanese Patent Laid-Open No. 2011-205463, a configuration is discussed in which a plurality of rotational members arranged in a width direction is disposed in a conveyance guide so as to reduce the conveyance load caused by friction between the documents and the conveyance guide.

Meanwhile, in an image reading apparatus, an ADF is generally supported so as to be openable and closable with respect to a reader (the main body of the image reading apparatus). In such a configuration, the ADF is provided with swingable guide members for guiding the leading edge of a sheet or sheets of an individual document from the reader into the inside of the ADF.

However, the orientation of the swingable guide members changes depending on the position of the ADF that has been closed. Thus, the size of the gap formed by the swingable guide members in the conveyance path is unstable. This may cause instability of a document being conveyed at the position of a swingable guide member, causing deterioration of the read image quality.

### SUMMARY

The present disclosure is directed to providing a document conveyance apparatus, an image reading apparatus, and an image forming apparatus that are capable of stabilizing the conveyance of documents at the swingable guide members and reducing the deterioration of the read image quality.

An aspect of the present disclosure provides a document conveyance apparatus openably and closably provided with respect to a reading section that includes a transparent member, a reading unit configured to read an image of a document conveyed by the document conveyance apparatus via the transparent member, and a plurality of scoop-up guides disposed at intervals in a width direction perpendicular to a conveyance direction of the document and configured to pick up and guide a leading edge of the document conveyed from the transparent member into the document conveyance apparatus. The document conveyance apparatus includes a conveyance member configured to convey the document; a conveyance guide member movable in a document thickness direction and configured to guide the document at a reading position of the reading unit; a plurality of rotational members provided in the conveyance guide member, disposed downstream of the reading position in the conveyance direction; and a plurality of swingable guide members arranged alternately with the scoop-up guides in a state in which the document conveyance apparatus is closed with respect to the reading section. One of the plurality of swingable guide members is disposed at a position that faces at least one of the plurality of rotational members.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming apparatus.

FIG. 2 is a perspective view of an image reading apparatus.

FIG. 3 is a schematic sectional view of the image reading apparatus.

FIG. 4 illustrates the image reading apparatus with an ADF opened.

FIG. 5 is an enlarged sectional view of a reading position and its surrounding area of the image reading apparatus.

FIG. 6 is a perspective view of a platen guide unit.

FIG. 7 is a plan view of the platen guide unit as viewed from below.

FIG. 8 illustrates the reading position and its surrounding area of the image reading apparatus as viewed from above.

### DESCRIPTION OF THE EMBODIMENTS

An embodiment of the present disclosure will now be described with reference to the attached drawings. The following embodiment provides a specific example of the present disclosure, without limiting the scope of the present disclosure.

### Image Forming Apparatus

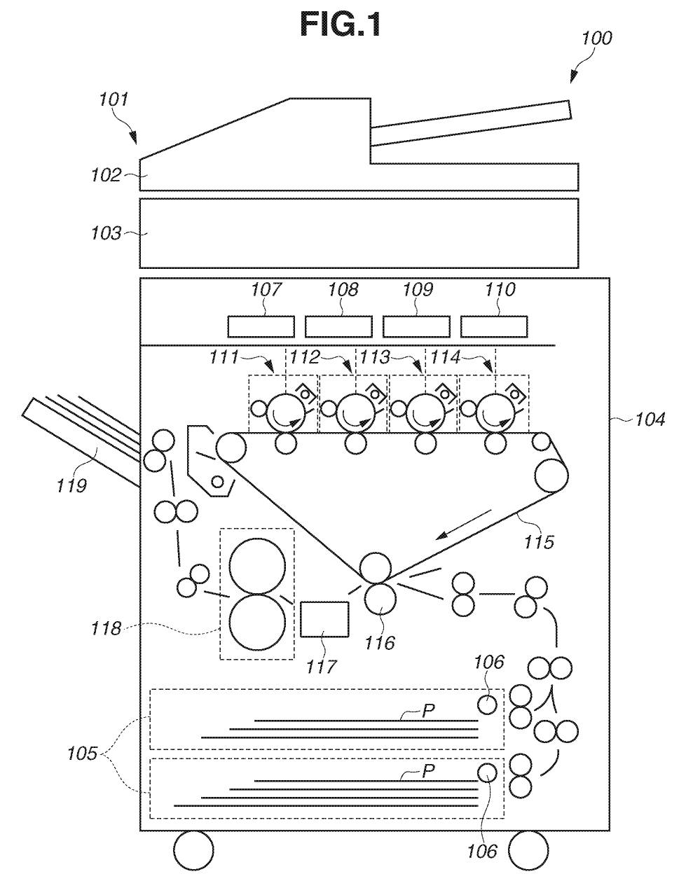

An image forming apparatus 100 according to the present embodiment will now be described with reference to FIG. 1. FIG. 1 is a sectional view of the image forming apparatus 100 as viewed from the front.

As illustrated in FIG. 1, the image forming apparatus 100 includes an image forming apparatus main body 104 that forms an image on a sheet P, and an image reading apparatus 101 provided over the image forming apparatus main body 104. The image forming apparatus 100 forms a toner image on the sheet P based on image data read by the image reading apparatus 101 or an image signal received from a host device, such as a personal computer, that is communicably connected to the image forming apparatus 100. Examples of the sheet P as a recording medium include sheet materials, such as plain paper, plastic film, and cloth.

The image forming apparatus main body 104 contains an electrophotographic image forming section which includes four laser scanners 107 to 110 corresponding to yellow (Y), magenta (M), cyan (C) and black (K), respectively, four image forming units 111 to 114, and a fixing unit 118. The laser scanners 107 to 110 emit laser beams to the respective photosensitive members included in the image forming units 111 to 114 based on received image signals. These image forming units 111 to 114 are arranged horizontally (in the left-right direction in FIG. 1) along an intermediate transfer belt 115.

In the image forming unit 111, a yellow toner image is formed, and the formed yellow toner image is primarily transferred to the intermediate transfer belt 115. In the image forming unit 112, a magenta toner image is formed, and the formed magenta toner image is primarily transferred onto the yellow toner image that has already been transferred to the intermediate transfer belt 115. In the image forming unit 113, a cyan toner image is formed, and the formed cyan toner image is primarily transferred onto the yellow and magenta toner images that have already been transferred to the intermediate transfer belt 115. In the image forming unit 114, a black toner image is formed, and the formed black toner image is primarily transferred onto the yellow, magenta, and cyan toner images that have already been transferred to the intermediate transfer belt 115.

Sheet feeding cassettes 105 are disposed in the lower portion of the image forming apparatus main body 104 so that the sheet feeding cassettes 105 can be pulled to the front side. The image forming apparatus 100 feeds, by using a pickup roller 106, a sheet P housed in a sheet feeding cassette 105 to a secondary transfer nip portion where the intermediate transfer belt 115 and a secondary transfer unit 116 are in contact with each other. The image forming apparatus 100 conveys the sheet P in synchronization with the toner image on the intermediate transfer belt 115. The multi-layer toner image on the intermediate transfer belt 115 is transferred to the sheet P at the secondary transfer nip portion by the action of a secondary transfer bias voltage applied to the secondary transfer unit 116.

The sheet P with the toner image secondarily transferred thereto by the secondary transfer unit 116 is conveyed to the fixing unit 118 by a conveyance belt 117. The fixing unit 118 heats and presses the sheet P to fix the toner image to the sheet P. After the toner image is fixed to the surface of the sheet P, the sheet P is discharged to a sheet discharge tray 119.

Further, in the present embodiment, the image forming apparatus 100 includes an electrophotographic image forming section. However, the type of image forming section is not particularly limited to the above configuration, and another type of image forming section, such as an inkjet image forming section, may be employed.

### Image Reading Apparatus

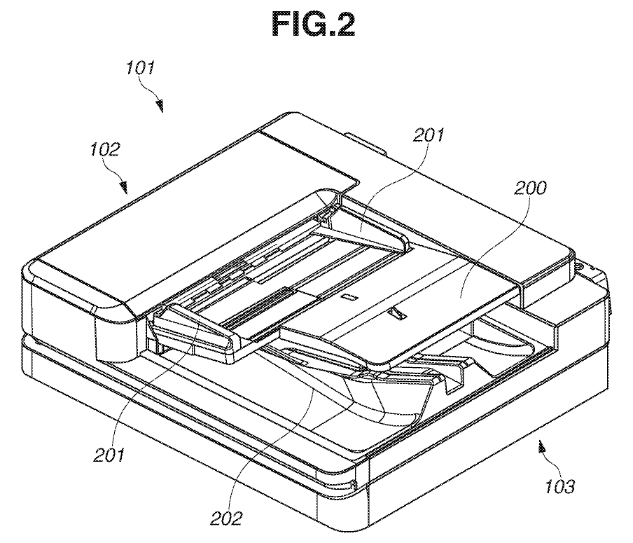

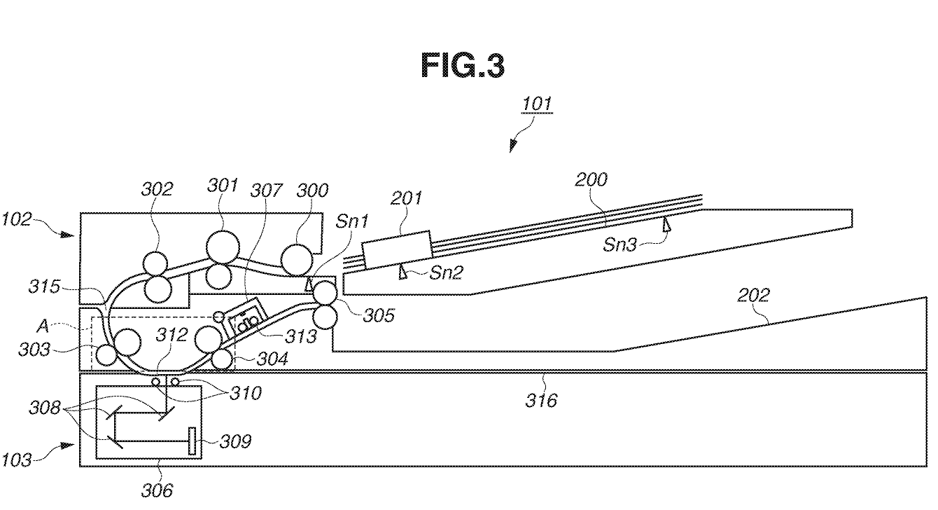

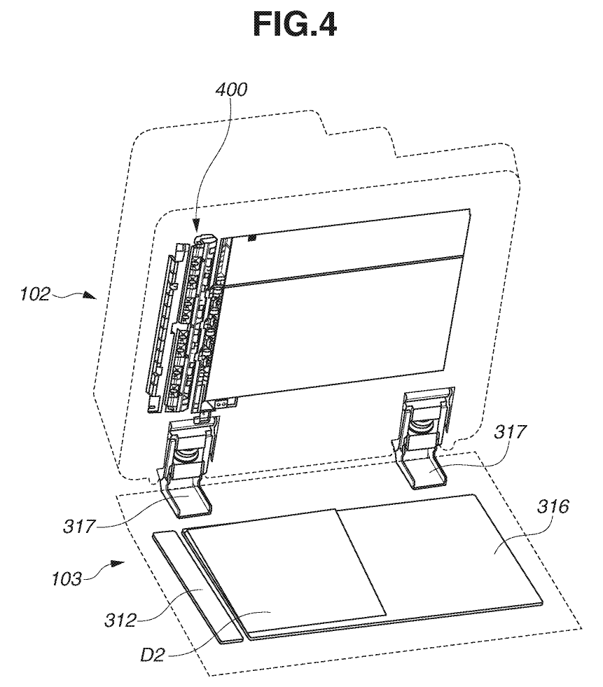

The image reading apparatus 101 will now be described with reference to FIGS. 2, 3, and 4. FIG. 2 is a perspective view of the image reading apparatus 101. FIG. 3 is a schematic sectional view of the image reading apparatus 101. FIG. 4 is a schematic diagram illustrating the image reading apparatus 101 with an automatic document feeder (ADF) 102 opened.

The image reading apparatus 101 includes a reader 103 and the ADF 102. The reader 103 is attached to the upper portion of the image forming apparatus main body 104. As illustrated in FIG. 4, the ADF 102 is supported by the reader 103 via hinges 317, and is pivotably disposed (openable and closable) with respect to the reader 103. The ADF 102 is an example of a document conveyance apparatus that conveys documents. The reader 103 is an example of a reading section of the image reading apparatus 101.

As illustrated in FIG. 3, the reader 103 includes a first reading unit 306, a platen glass 312, and a document positioning glass 316. The platen glass 312 is an example of a transparent member. The ADF 102 includes a document tray 200, a discharge tray 202, a second reading unit 307, and a platen glass 313. The ADF 102 further includes a pickup roller 300, a pair of separation rollers 301, a pair of drawing rollers 302, a pair of first lead rollers 303, a pair of second lead rollers 304, and a pair of discharge rollers 305. These conveyance rollers (300 to 305) are all examples of conveyance members that convey a document D1.

The first reading unit 306 and the second reading unit 307 are each an example of a reading unit that reads image information from conveyed documents. According to the present embodiment, the first reading unit 306 is an image sensor unit including a charge-coupled device (CCD) sensor, and the second reading unit 307 is an image sensor unit including a contact image sensor (CIS). The first reading unit 306 includes a sensor substrate 309 on which light-receiving elements are arranged in a line in a sheet-width direction, a light source 310 that emits light to the document D1, and a plurality of mirrors 308 included in a reduction optical system that forms an optical image of the document D1 on the light-receiving surface of the sensor substrate 309. The second reading unit 307 includes a complementary metal-oxide-semiconductor (CMOS) sensor substrate on which light-receiving elements are arranged in a line in a sheet-width direction, a light source that emits light to the document D1, and an equal-magnification optical system that forms an optical image of the document D1 on the light-receiving surface of the sensor substrate.

The first reading unit 306 and the second reading unit 307, which serve as the reading units according to the present embodiment, are both line sensors that acquire line images of the document D1 at a predetermined reading cycle. An individual line image is a single row of an image in which pixels are arranged in the sheet-width direction as the main scanning direction.

A control unit of the image reading apparatus 101 obtains image information as two-dimensional image data by connecting the line images acquired by the first reading unit 306 and the second reading unit 307 in a sub-scanning direction (document conveyance direction).

The pickup roller 300 is a pickup member that feeds the document D1 from the document tray 200 as a placement unit on which the document D1 is placed. The pair of separation rollers 301 includes a feed roller and a separation roller. The feed roller is a feeding member that feeds the document D1 from the document tray 200. The separation roller is in contact with the feed roller, and these rollers form a separation nip.

The separation roller is an example of a separation member that separates sheets by applying frictional force to a sheet. The separation roller may be a roller member supported by a shaft member fixed to a frame body of the ADF 102 via a torque limiter. The separation roller may be a retard roller to which a driving force is applied via the torque limiter in a direction (the clockwise direction in FIG. 3) opposite to the moving direction (the document feeding direction) of the document D1 at the separation nip. Further, instead of using the separation roller, a pad-shaped elastic member (a rubber pad) that is in contact with the feed roller may be used as the separation member.

The image reading apparatus 101 is capable of performing an image reading operation (a flow-reading operation) in which the first reading unit 306 and the second reading unit 307 read image information about the document D1 while the ADF 102 is conveying the sheets of the document D1 one by one. When the image reading operation is started, the pickup roller 300 rotates while being in contact with the uppermost sheet of the document D1 on the document tray 200, and feeds the uppermost sheet of the document D1 from the document tray 200. Of the pair of separation rollers 301, the feed roller conveys the document D1 while the separation roller applies friction force to the document D1 in the direction opposite to the document feeding direction at the separation nip. When a plurality of sheets of the document D1 enters the separation nip, the separation roller prevents the sheets of the document D1 other than a single sheet of the document D1 that is in contact with the feed roller from passing through the separation nip. In this manner, the single sheet of the document D1 passes through the separation nip after being separated from the other sheets.

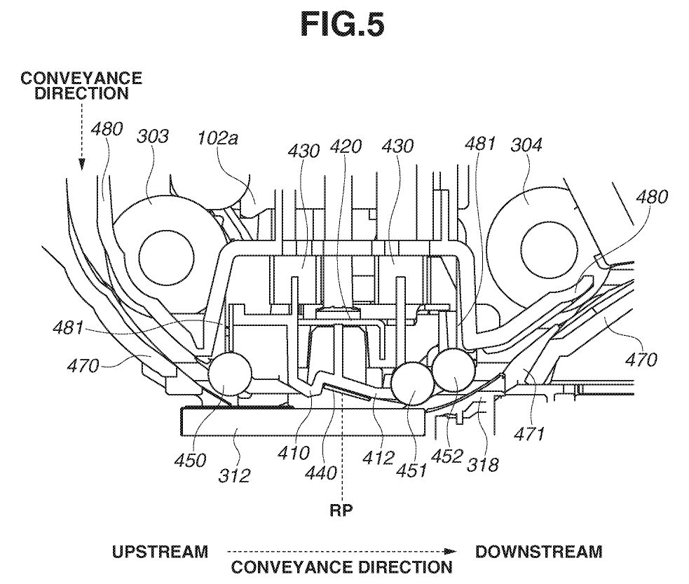

The sheet of the document D1 that has passed through the separation nip is conveyed by the pair of drawing rollers 302, the pair of first lead rollers 303, and the pair of second lead rollers 304 in that order. During this process, the first reading unit 306 optically scans a first side (the front side) of the sheet of the document D1 through the platen glass 312 at a reading position RP (refer to FIG. 5) to convert the optically scanned image into an electronic signal. The second reading unit 307 optically scans a second surface (the back surface) of the sheet of the document D1 through the platen glass 313 to convert the optically scanned image into an electronic signal. In this manner, the image information as the electronic image data is obtained. The sheet of the document D1 where the image information has been read is discharged from the conveyance path in the ADF 102 by the pair of discharge rollers 305 to be placed on the discharge tray 202.

The image reading apparatus 101 is also capable of reading image information from a still document placed on the reader 103. In this case, as illustrated in FIG. 4, the user opens the ADF 102, places a document D2 on the document positioning glass 316 of the reader 103, closes the ADF 102, and gives an instruction to perform reading. In response to the instruction, the first reading unit 306 optically scans the document D2 while moving in the sub-scanning direction to obtain image information.

### Document Detection Mechanism of ADF

Further, the ADF 102 includes a detection unit (a size detection unit) that detects the size of a sheet of a document. The size detection unit according to the present embodiment includes a document sensor Sn1, a document-width sensor Sn2, and a document-length sensor Sn3. The document sensor Sn1, the document-width sensor Sn2, and the document-length sensor Sn3 are examples of size acquisition units that obtain information about the size of the sheets of the document D1. The size acquisition unit may be an operation panel that allows the user to enter a document size.

The document sensor Sn1 and the document-length sensor Sn3 are each a sensor that detects the presence or absence of the document D1 at a predetermined position on the document tray 200. The document sensor Sn1 is disposed near the downstream end position of the document tray 200 in the document feeding direction. The document-length sensor Sn3 is disposed at a position distant from the document sensor Sn1 by a predetermined length upstream in the document feeding direction. A reflective or transmissive optical sensor can be used as each of the document sensor Sn1 and the document-length sensor Sn3.

The document-width sensor Sn2 detects the width of a document in the width direction perpendicular to the document feeding direction (the document conveyance direction). As the document-width sensor Sn2, an optical sensor, such as a photo-interrupter that detects the positions of light shielding plates provided on side regulating plates 201 of the document tray 200, can be used. The side regulating plates 201 are a pair of regulating members that synchronously move in the document-width direction and regulate both side ends of the document (FIG. 2).

The control unit of the image reading apparatus 101 determines the presence or absence of the document D1 on the document tray 200 based on a detection result of the document sensor Sn1. The control unit of the image reading apparatus 101 determines the length of the document D1 on the document tray 200 in the document-width direction (hereinafter, this length may simply be referred to as a document width), based on a detection result of the document-width sensor Sn2. The control unit of the image reading apparatus 101 determines whether the length of the document D1 on the document tray 200 in the document feeding direction (hereinafter, this length may simply be referred to as a document length) is equal to or more than a predetermined length based on a detection result of the document-length sensor Sn3.

### Configuration of Platen Guide Unit

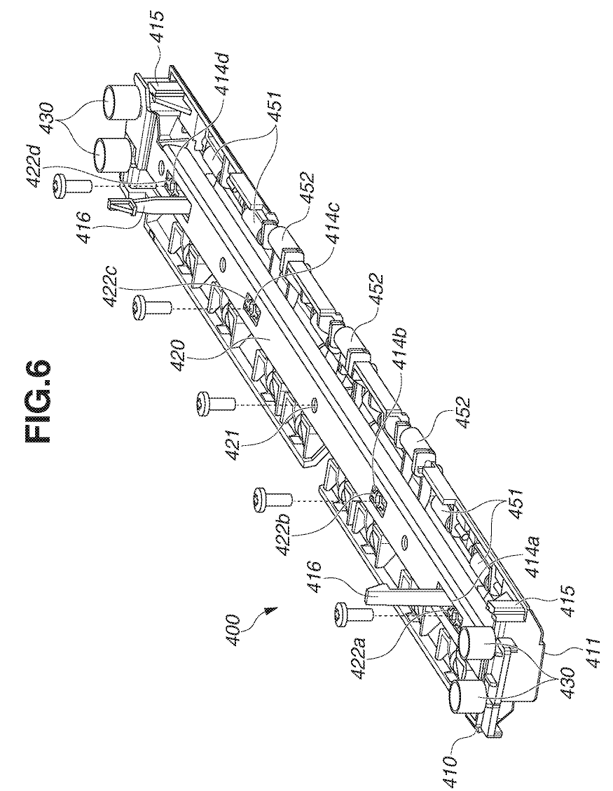

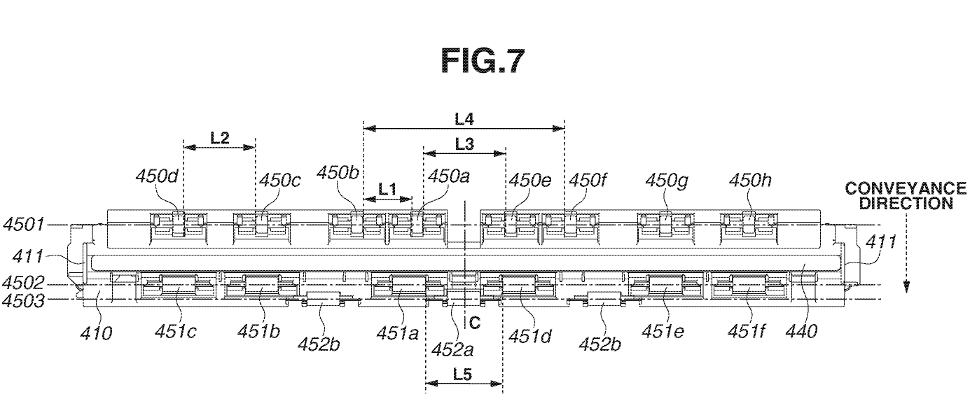

A configuration of a platen guide unit 400 will now be described with reference to FIGS. 5, 6, and 7. FIG. 5 is an enlarged view of a region A (refer to FIG. 3) including the reading position RP and its surrounding area. FIG. 6 illustrates components constituting the platen guide unit 400. FIG. 7 is a plan view of the platen guide unit 400 as viewed from the conveyance path (from the platen glass 312).

The platen guide unit 400 is disposed facing the platen glass 312 at the reading position RP of the first reading unit 306, and guides documents at the reading position RP.

The platen guide unit 400 includes a platen guide 410, a reinforcement member 420, biasing members 430, a white member 440, and a plurality of rotational members (450, 451, and 452). The platen guide unit 400 is movably attached to a housing 102a of the ADF 102 in a document thickness direction (the height direction in FIG. 5 or the vertical direction), and is biased toward the platen glass 312 by the biasing members 430, which are springs.

The platen guide 410 is a main component of the platen guide unit 400, and forms a guide surface to guide documents. The platen guide 410 is an example of a conveyance guide member. The reinforcement member 420, which is a component made of a metal material, reinforces the resin platen guide 410 to prevent deformation of the platen guide 410. The white member 440 is a white plate-shaped component. The white member 440 serves as the background when the first reading unit 306 reads a document image at the reading position RP.

The plurality of rotational members provided in the platen guide unit 400 includes a plurality of rotational members 450 disposed upstream of the reading position RP and a plurality of rotational members 451 and 452 disposed downstream of the reading position RP. As illustrated in FIG. 7, the plurality of rotational members 450 disposed upstream of the reading position RP is composed of eight rotational members 450a to 450h. In a case where it is not necessary to particularly distinguish the rotational members 450a to 450h from each other, those rotational members may collectively be referred to as rotational members 450. Similarly, the plurality of rotational members 451 disposed downstream of the reading position RP is composed of six rotational members 451a to 451f. In a case where it is not necessary to particularly distinguish the rotational members 451a to 451f from each other, those rotational members may collectively be referred to as rotational members 451. Similarly, the plurality of rotational members 452 disposed downstream of the reading position RP is composed of three rotational members 452a to 452c. In a case of not particularly distinguishing the rotational members 452a to 452c from each other, those rotational members may be referred to as the rotational members 452.

The plurality of rotational members 450, 451, and 452 is driven rollers that are rotated by coming into contact with a document conveyed by the pair of first lead rollers 303 and the pair of second lead rollers 304. Thus, the rotational members 450, 451, and 452 are simply rotatably attached to the platen guide 410, and do not receive any driving force from a driving source, such as a motor.

The conveyance of a document in the region A including the reading position RP and its surrounding area will now be described in detail. A sheet of a document fed by the pair of drawing rollers 302 is nipped by the pair of first lead rollers 303, to be conveyed along the conveyance path formed by an outer guide member 470 and an inner guide member 480 provided in the housing 102a of the ADF 102. The sheet of the document conveyed by the pair of first lead rollers 303 comes into contact with the plurality of rotational members 450 disposed in the platen guide unit 400 to be conveyed into the gap between the platen glass 312 and the white member 440. At this time, the first reading unit 306 reads an image of the sheet of the document at the reading position RP.

Scoop-up guides 318 are provided adjacent to the platen glass 312 of the reader 103 (on the right side of the platen glass 312 in FIG. 5). The scoop-up guides 318 each have a curved surface that rises upward toward the downstream side in the conveyance direction, and are arranged at intervals in the width direction. Further, swingable guide members 471 are provided on a portion of the outer guide member 470 which is adjacent to the platen glass 312. The plurality of swingable guide members 471 is provided swingably about the downstream side in the conveyance direction with respect to the outer guide member 470, and is arranged at intervals in the width direction.

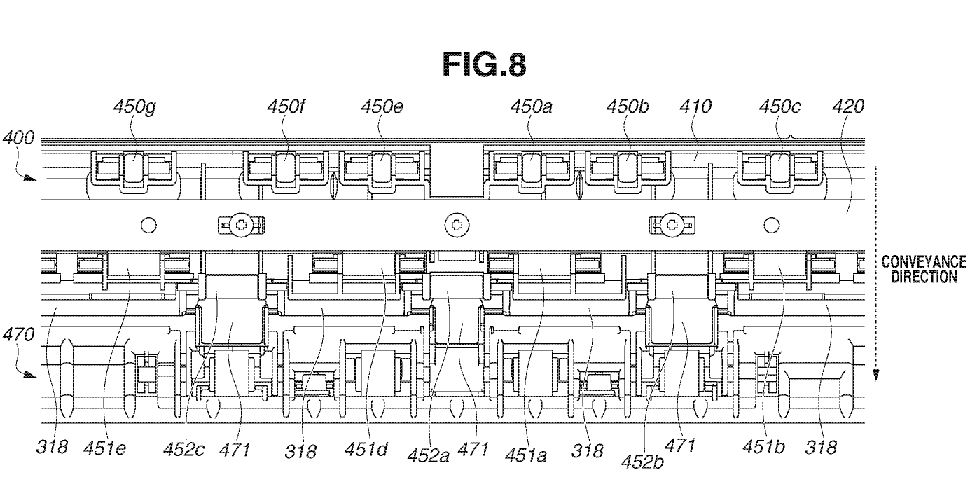

As illustrated in FIG. 8, each of the swingable guide members 471 is disposed at a position so that an individual swingable guide member 471 is disposed between two of the scoop-up guides 318 disposed at intervals in the width direction when the ADF 102 is closed. Thus, the swingable guide members 471 are disposed so that the swingable guide members 471 overlap at least part of the scoop-up guides 318 as viewed in the width direction when the ADF 102 is closed. In other words, the plurality of scoop-up guides 318 and the plurality of swingable guide members 471 are alternately arranged in the width direction.

The end portions of the scoop-up guides 318 upstream in the conveyance direction are positioned below the upper surface of the platen glass 312. Further, when the ADF 102 is closed, the end portions of the swingable guide members 471 upstream in the conveyance direction are also positioned below the upper surface of the platen glass 312.

Thus, the leading edge of the sheet of the document that has passed through the reading position RP is picked up by the scoop-up guides 318 and the swingable guide members 471 to be guided into the inside of the ADF 102. The sheet of the document is conveyed to the pair of second lead rollers 304 through the conveyance path while being in contact with the rotational members 451 and 452 of the platen guide unit 400.

As described above, according to the present embodiment, a sheet of a document comes into contact with the plurality of rotational members 450, 451, and 452 in the vicinity of the reading position RP. Further, the plurality of rotational members 450, 451, and 452 restricts lifting of the sheet of the document at the reading position RP. Thus, the position of the platen guide unit 400 in the height direction and in the conveyance direction significantly affects the read image quality.

Thus, according to the present embodiment, the platen guide unit 400 is attached to the housing 102a of the ADF 102 so that the platen guide unit 400 can be moved in the height direction. Further, as illustrated in FIG. 6, abutment portions 411 protruding downward are formed outside a document passing region in the width direction of the platen guide 410, and the biasing members 430 are attached to the upper portions of the abutment portions 411. This configuration establishes a state where the platen guide 410 is biased toward the platen glass 312 by the biasing members 430, and the abutment portions 411 abut the platen glass 312. In this manner, the position of the platen guide unit 400 in the height direction is determined, ensuring the gap between the platen glass 312 and the white member 440 at an appropriate distance. Further, the position of the platen guide unit 400 in the conveyance direction is restricted by a state where protruding portions 481 provided on the inner guide member 480 and surface portions 415 provided on the platen guide 410 are in contact with each other.

When the ADF 102 is opened with respect to the reader 103 as illustrated in FIG. 4, the platen guide unit 400 is exposed to the outside but may be detached from the housing 102a. To prevent this, two hook portions 416 (refer to FIG. 6) extending upward are formed on the platen guide 410, and those hook portions 416 engage with the inner guide member 480 so as to prevent the platen guide unit 400 from being detached from the housing 102a.

The control unit of the image reading apparatus 101 performs image processing, such as skew correction, based on the shadow of a sheet of a document in a read image. Thus, it is desirable for the shadow of the leading edge of the sheet of the document reflected in the background to be dark when the first reading unit 306 reads the image of the sheet of the document. For this reason, an inclined portion 412, which is inclined downward toward the downstream side in the conveyance direction, is formed on the platen guide 410, and the white member 440 serving as the background of the read image is attached to the inclined portion 412. In this manner, light emitted from the light source 310 positioned upstream of the reading position RP causes the shadow of the leading edge of the sheet of the document projected onto the white member 440 to be darker. According to the present embodiment, the inclined portion 412 is inclined by 17 degrees with respect to the platen glass 312 (in a horizontal direction). The angle of the inclined portion 412 with respect to the horizontal direction may be 10 to 20 degrees.

As described above, the platen guide 410 includes components having complicated shapes, such as the abutment portions 411 and the inclined portion 412. To achieve these shapes, the platen guide 410 is made of a resin material. However, the platen guide 410 made of a resin material may have an increased variation of component dimensions due to warpage generated during molding, or may be deformed due to reaction force received from the document. Thus, the platen guide unit 400 according to the present embodiment is provided with the reinforcement member 420 made of metal. The reinforcement member 420 has an elongated shape extending in the width direction, and has a hole portion 421 and long hole portions 422a and 422d formed therein. Four protruding portions 414a to 414d protruding upward are formed on the opposite side (the back side) of the conveyance path of the platen guide 410, and are inserted into the long hole portions 422a and 422d, respectively. The two hook portions 416 described above are inserted into the long hole portions 422a and 422d. In this state, screws are engaged with the hole portion 421 and the four protruding portions 414a to 414d, so that the reinforcement member 420 is fixed to the platen guide 410.

### Arrangement of Rotational Members in Platen Guide Unit

The arrangement of the plurality of rotational members in the platen guide unit 400 will now be described. As described above, the plurality of rotational members 450 disposed upstream of the reading position RP and the plurality of rotational members 451 and 452 disposed downstream of the reading position RP are rotatably attached to the platen guide unit 400.

First, the arrangement of the plurality of rotational members 450 disposed upstream of the reading position RP will be described. As illustrated in FIG. 7, the plurality of rotational members 450, i.e., the eight rotational members 450a to 450h, is arranged in a line in the width direction in the platen guide unit 400. The rotational members 450a to 450h rotate about a common first rotational axis 4501. The four rotational members 450a to 450d are disposed on one side (the left side in FIG. 7) of a conveyance center C, which is the center of the conveyance path in the width direction, and the four rotational members 450e to 450h are disposed on the other side (the right side in FIG. 7). The rotational members 450a to 450d and the rotational members 450e to 450h are symmetric with respect to the conveyance center C.

A distance L1 between the adjacent rotational members 450a and 450b, which are positioned near the conveyance center C, is shorter than a distance L2 between the adjacent rotational members 450c and 450d, which are positioned far from the conveyance center C (L1 < L2). In other words, on one side of the conveyance center C, as two adjacent rotational members are positioned closer to the conveyance center C, the distance between the two adjacent rotational members is shorter. According to the present embodiment, L1 = 25.6 mm and L2 = 35.6 mm. Further, the distance between two adjacent rotational members is the distance from an end portion of one rotational member to an end portion of the other rotational member.

According to the present embodiment, a distance L3 between the rotational member 450a and the rotational member 450e, which are positioned the closest to the conveyance center C, is 40 mm. A distance L4 between the rotational member 450b and the rotational member 450f, which are positioned the second closest to the conveyance center C, is 91.2 mm.

According to the present embodiment, a document having a width equal to or less than the A6 size (105 mm in width) may referred to as a small-size document, and a document having a width more than the A6 size may referred to as a large-size document. The plurality of rotational members 450 is arranged so that, when an A6-size document, which is the small-size document, is conveyed, the four rotational members (450a, 450b, 450e, and 450f) can come into contact with the document on the upstream side of the reading position RP. Further, the minimum conveyable document size based on the product specifications of the ADF 102 according to the present embodiment is a name-card size, which is 48 mm in width. Thus, even when the document having the minimum conveyable size is conveyed, the two rotational members, which are the rotational member 450a and the rotational member 450e, are capable of coming into contact with the document on the upstream side of the reading position RP.

To allow the two rotational members to come into contact with a name-card-size document being conveyed, it is sufficient that the distance L3 between the rotational member 450a and the rotational member 450e, which are positioned the closest to the conveyance center C, is 48 mm or less. To allow the four rotational members to come into contact with an A6-size document being conveyed, it is sufficient that the distance L4 between the rotational member 450b and the rotational member 450f, which are positioned the second closest to the conveyance center C, is 105 mm or less.

Next, the arrangement of the plurality of rotational members 451 and 452 disposed downstream of the reading position RP will be described. As illustrated in FIG. 7, the plurality of rotational members 451, i.e., the six rotational members 451a to 451f, is arranged in a line in the width direction in the platen guide unit 400. The rotational members 451a to 451f rotate about a common second rotational axis 4502. Further, the plurality of rotational members 452, i.e., the three rotational members 452a to 452c, is arranged in a line in the width direction in the platen guide unit 400. The rotational members 452a to 452c rotate about a common third rotational axis 4503.

The three rotational members 452a to 452c are disposed downstream of the six rotational members 451a to 451f in the conveyance direction, and the rotational members 451 and the rotational members 452 are disposed partially overlapping each other as viewed from the rotational axis direction. The six rotational members 451a to 451f are examples of a plurality of first rotational members. The three rotational members 452a to 452c are examples of a plurality of second rotational members. The eight rotational members 450a to 450h described above are examples of a plurality of third rotational members.

According to the present embodiment, a distance L5 between the rotational member 451a and the rotational member 451d, which are positioned the closest to the conveyance center C of the plurality of rotational members 451, is 46.8 mm. The rotational member 452a is disposed at the conveyance center C. Thus, even when a document having the minimum conveyable size is conveyed, the three rotational members, which are the rotational member 451a, the rotational member 451d, and the rotational member 452a, are capable of coming into contact with the document downstream of the reading position RP.

When an A3-size document (297 mm in width), which is a large-size document, is conveyed, the rotational members 450a to 450h, the rotational members 451a to 451f, and the rotational members 452a to 452c all come into contact with the document.

### Positional Relationship between Swingable Guide Members and Rotational Members

A positional relationship between the swingable guide members 471 provided on the outer guide member 470 of the ADF 102 and the plurality of rotational members 452 will now be described. As described above, the plurality of scoop-up guides 318 and the plurality of swingable guide members 471 are alternately arranged in the width direction at a position adjacent to the platen glass 312. The plurality of rotational members 452a to 452c is disposed overlapping the plurality of swingable guide members 471 in the conveyance direction. Further, when the ADF 102 is viewed from below, the plurality of rotational members 452a to 452c overlaps at least part of the plurality of swingable guide members 471. In other words, the plurality of swingable guide members 471 is disposed at positions that face the plurality of rotational members 452a to 452c.

### Summary of Present Embodiment

As described above, according to the present embodiment, the distance L1 between the adjacent rotational members 450a and 450b, which are positioned near the conveyance center C, is shorter than the distance L2 between the adjacent rotational members 450c and 450d, which are positioned far from the conveyance center C (L1 < L2). This configuration makes it possible for more rotational members to come into contact with even a document having a small-size, stabilizing the conveyance of small-size documents.

According to the present embodiment, the distance L3 between the rotational member 450a and the rotational member 450e, which are positioned the closest to the conveyance center C, is shorter than the width of a document having the minimum conveyable size. This configuration makes it possible for a plurality of rotational members to come into contact with even a document having a minimum-size, stabilizing the conveyance of minimum-size documents.

The plurality of rotational members 450a to 450h is arranged symmetrically with respect to the conveyance center C. This configuration allows the conveyance load on a sheet of a document to be almost even in the width direction, reducing the skew of document sheets.

The alternate arrangement of the swingable guide members 471 and the plurality of scoop-up guides 318 allows the leading edge of a sheet of a document to be smoothly guided from the platen glass 312 into the inside of the ADF 102. Further, the swingable arrangement of the swingable guide members 471 allows, when the ADF 102 is closed, the swingable guide members 471 to be brought into an orientation suitable for conveyance with the swingable guide members 471 being in contact with the upper surface of the reader 103. On the other hand, the configuration that the swingable guide members 471 are swingable makes unstable the size of the gap formed in the conveyance path by the swingable guide members 471. For example, a large gap formed by the swingable guide members 471 in the conveyance path may cause a sheet of a document to lift, adversely affecting the read image quality.

However, according to the present embodiment, the plurality of rotational members 452a to 452c is disposed at positions that face the swingable guide members 471. This configuration can reduce the gap formed by the swingable guide members 471 in the conveyance path, stabilizing the conveyance of sheets of documents.

According to the present disclosure, a document conveyance apparatus, an image reading apparatus, and an image forming apparatus can be provided that are capable of reducing the deterioration of the read image quality by stabilizing the document conveyance using swingable guide members.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060808, filed Apr. 1, 2025, which is hereby incorporated by reference herein in its entirety.

What is claimed is:

1. A document conveyance apparatus openably and closably provided with respect to a reading section
that includes a transparent member, a reading unit configured to read an image of a document conveyed by the document conveyance apparatus via the transparent member, and a plurality of scoop-up guides disposed at intervals in a width direction perpendicular to a conveyance direction of the document and configured to pick up and guide a leading edge of the document conveyed from the transparent member into the document conveyance apparatus, the document conveyance apparatus comprising:
a conveyance member configured to convey the document;
a conveyance guide member movable in a document thickness direction and configured to guide the document at a reading position of the reading unit;
a plurality of rotational members provided in the conveyance guide member, disposed downstream of the reading position in the conveyance direction; and
a plurality of swingable guide members arranged alternately with the scoop-up guides in a state in which the document conveyance apparatus is closed with respect to the reading section,
wherein one of the plurality of swingable guide members is disposed at a position that faces at least one of the plurality of rotational members.

2. The document conveyance apparatus according to claim 1,
wherein the plurality of rotational members includes a plurality of first rotational members arranged in a line in the width direction on a downstream side of the reading position in the conveyance direction, and a plurality of second rotational members arranged in a line in the width direction on a downstream side of the plurality of first rotational members in the conveyance direction so as to partially overlap the plurality of first rotational members as viewed from the width direction, and
wherein one of the plurality of swingable guide members is disposed at a position that faces the plurality of second rotational members of the plurality of rotational members.

3. The document conveyance apparatus according to claim 2, wherein the conveyance guide member includes a plurality of third rotational members arranged in a line in the width direction on an upstream side of the reading position in the conveyance direction.

4. The document conveyance apparatus according to claim 1, wherein the plurality of rotational members is arranged symmetrically with respect to a center of a conveyance path.

5. The document conveyance apparatus according to claim 1, wherein the conveyance guide member is made of a resin material, and a metal reinforcement member is attached to the conveyance guide member on an opposite side of a conveyance path.

6. The document conveyance apparatus according to claim 1, wherein the conveyance guide member has an inclined portion at the reading position, the inclined portion being inclined downward toward a downstream side in the conveyance direction.

7. A document conveyance apparatus openably and closably provided with respect to a reading section that includes a transparent member, a reading unit configured to read an image of a document conveyed by the document conveyance apparatus via the transparent member, and a plurality of scoop-up guides disposed at intervals in a width direction perpendicular to a conveyance direction of the document and configured to pick up and guide a leading edge of the document being conveyed from the transparent member into the document conveyance apparatus,
the document conveyance apparatus comprising:
a conveyance member configured to convey the document;
a conveyance guide member movable in a document thickness direction and configured to guide the document at a reading position of the reading unit;
a plurality of rotational members provided in the conveyance guide member, disposed downstream of the reading position in the conveyance direction; and
a plurality of swingable guide members arranged to overlap at least part of the scoop-up guides as viewed from the width direction in a state in which the document conveyance apparatus is closed with respect to the reading section,
wherein one of the plurality of swingable guide members is disposed at a position that faces at least one of the plurality of rotational members.

8. The document conveyance apparatus according to claim 7,
wherein the plurality of rotational members includes a plurality of first rotational members arranged in a line in the width direction on a downstream side of the reading position in the conveyance direction, and a plurality of second rotational members arranged in a line in the width direction on a downstream side of the plurality of first rotational members in the conveyance direction so as to partially overlap the plurality of first rotational members as viewed from the width direction, and
wherein one of the plurality of swingable guide members is disposed at a position that faces the plurality of second rotational members of the plurality of rotational members.

9. The document conveyance apparatus according to claim 8, wherein the conveyance guide member includes a plurality of third rotational members arranged in a line in the width direction on an upstream side of the reading position in the conveyance direction.

10. The document conveyance apparatus according to claim 7, wherein the plurality of rotational members is arranged symmetrically with respect to a center of a conveyance path.

11. The document conveyance apparatus according to claim 7, wherein the conveyance guide member is made of a resin material, and a metal reinforcement member is attached to the conveyance guide member on an opposite side of a conveyance path.

12. The document conveyance apparatus according to claim 7, wherein the conveyance guide member has an inclined portion at the reading position, the inclined portion being inclined downward toward a downstream side in the conveyance direction.

13. An image reading apparatus comprising:
a reading section configured to read an image of a document; and
a document conveyance apparatus configured to convey the document, and is openably and closably provided with respect to the reading section, wherein:
the reading section includes:
a transparent member;
a reading unit configured to read the image of the document conveyed by the document conveyance apparatus via the transparent member; and
a plurality of scoop-up guides disposed at intervals in a width direction perpendicular to a conveyance direction of the document and configured to pick up and guide a leading edge of the document being conveyed from the transparent member into the document conveyance apparatus,
the document conveyance apparatus includes:
a conveyance member configured to convey the document;
a conveyance guide member movable in a document thickness direction and configured to guide the document at a reading position of the reading unit;
a plurality of rotational members provided in the conveyance guide member, disposed downstream of the reading position in the conveyance direction; and
a plurality of swingable guide members arranged alternately with the scoop-up guides in a state in which the document conveyance apparatus is closed with respect to the reading section,
wherein one of the plurality of swingable guide members is disposed at a position that faces at least one of the plurality of rotational members.

14. The image reading apparatus according to claim 13,
wherein the plurality of rotational members includes a plurality of first rotational members arranged in a line in the width direction on a downstream side of the reading position in the conveyance direction, and a plurality of second rotational members arranged in a line in the width direction on a downstream side of the plurality of first rotational members in the conveyance direction so as to partially overlap the plurality of first rotational members as viewed from the width direction, and
wherein one of the plurality of swingable guide members is disposed at a position that faces the plurality of second rotational members of the plurality of rotational members.

15. The image reading apparatus according to claim 13, wherein the conveyance guide member includes a plurality of third rotational members arranged in a line in the width direction on an upstream side of the reading position in the conveyance direction.

16. The image reading apparatus according to claim 13, wherein the plurality of rotational members is arranged symmetrically with respect to a center of a conveyance path.

17. The image reading apparatus according to claim 13, wherein the conveyance guide member is made of a resin material, and a metal reinforcement member is attached to the conveyance guide member on an opposite side of a conveyance path.

18. The image reading apparatus according to claim 13, wherein the conveyance guide member has an inclined portion at the reading position, the inclined portion being inclined downward toward a downstream side in the conveyance direction.

19. The image reading apparatus according to claim 13, wherein the plurality of guide members is arranged to overlap at least part of the scoop-up guides as viewed from the width direction in a state in which the document conveyance apparatus is closed with respect to the reading section.

20. An image forming apparatus comprising:
the image reading apparatus according to claim 13; and
an image forming section configured to form an image on a sheet based on the image of the document read by the reading unit.
